(19) United States
(12) Patent Application Publication
(10) Pub. No.: US 2016/0275906 A1
(43) Pub. Date: Sep. 22, 2016

(54) PROVIDING CONTENT TO ELECTRONIC PAPER DISPLAY DEVICES

(71) Applicant: Microsoft Technology Licensing, LLC, Redmond, WA (US)

(72) Inventors: James Scott, Cambridge (GB); Nicholas Yen- Cherng Chen, Cambridge (GB); Stephen Edward Hodges, Cambridge (GB); John Franciscus Marie Helmes, Steyl (NL); Stuart Taylor, Cambridge (GB); Thomas Robert Kubitza, Stuttgart (DE); Sergey Antonovich, Chekhov (RU); Refael Zabdi Whyte, Hamilton (NZ)

(21) Appl. No.: 14/664,505

(22) Filed: Mar. 20, 2015

(51) Int. Cl. G09G 5/00; G06F 1/26; H04N 1/00

(52) U.S. Cl. CPC G09G 5/006; H04N 1/00129; G09G 5/005; G06F 1/266; G09G 2330/02

(57) ABSTRACT

A system provides a content service arranged to provide content for display on a display device which comprises an electronic paper display but which does not include a power source which is capable of providing sufficient power to update the electronic paper display. Instead, power is only provided to update the electronic paper display when in direct contact with a printer device. The power is provided via a contact based conductive digital data and power bus which also provides pixel data for content to be displayed on the electronic paper display. The display device further comprises a processing element which configured to drive the electronic paper display. The content service receives an identifier for a display device or printer device and identifies content based on the identifier received. The identified content is then transmitted to a printer device for display on a display device.

### BACKGROUND

Electronic paper (or e-paper) is commonly used for e-reader devices because it only requires power to change the image displayed and does not require continuous power to maintain the display in between. The electronic paper can therefore hold static images or text for long periods of time (e.g. from several minutes to several hours and even several days, months or years in some examples) without requiring significant power (e.g. without any power supply or with only minimal power consumption). There are a number of different technologies which are used to provide the display, including electrophoretic displays and electro-wetting displays. Many types of electronic paper displays are also referred to as ‘bi-stable’ displays because they use a mechanism in which a pixel can move between stable states (e.g. a black state and a white state) when powered but holds its state when power is removed.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A system provides a content service arranged to provide content for display on a display device which comprises an electronic paper display but which does not include a power source which is capable of providing sufficient power to update the electronic paper display. Instead, power is only provided to update the electronic paper display when in direct contact with a printer device. The power is provided via a contact based conductive digital data and power bus which also provides pixel data for content to be displayed on the electronic paper display. The display device further comprises a processing element which configured to drive the electronic paper display. The content service receives an identifier for a display device or printer device and identifies content based on the identifier received. The identified content is then transmitted to a printer device for display on a display device. In various examples the electronic paper display is a multi-stable display.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is schematic diagram of an example system comprising a content service, display device and printer device;

FIG. 2 is a schematic diagram showing the display device from FIG. 1 in more detail;

FIG. 3 is a schematic diagram showing the printer device from FIG. 1 in more detail;

FIG. 4 is a flow diagram showing an example method of operation of the content service shown in FIG. 1; and

FIG. 5 illustrates various components of an exemplary computing-based device which may run the content service shown in FIG. 1.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

As described above, current e-reader devices often use a bi-stable display because they have much lower power consumption than backlit LCD/LED displays which require power to be able to display anything. In contrast, a bi-stable display requires power to change state (i.e. change the image/text displayed) but not to maintain a static display. However, despite the difference in display technologies used by e-reader devices and tablet computers, the hardware architecture is very similar. Both types of device contain a battery, a processor, a communications module (which is usually wireless) and user interaction hardware (e.g. to provide a touch-sensitive screen and one or more physical controls such as buttons).

To obtain new content on a display device, a user typically creates an account with an e-reader content provider associated with their display device, logs into the display device using their account details and can then browse and select new content via the display device itself. Alternatively, a user can select new content via a web interface provided by the e-reader content provider which they navigate on another device (e.g. smartphone, tablet computer or desktop computer).

The embodiments described below are not limited to implementations which solve any or all of the disadvantages of known ways of providing content to display devices.

Described herein is a method of providing content for a display device which comprises an electronic paper display but which does not include a battery (or other power source) which provides sufficient power to update the electronic paper display. Instead, power to update the electronic paper display is provided to the display device via a contact based conductive digital data and power bus. This bus provides the pixel data for the electronic paper display to a processing element in the display device. The processing element drives the electronic paper display and only updates the electronic paper display when receiving power via the bus from a power supply external to the display device. The signals for the bus (i.e. the pixel data and the power) are provided by a ‘printer device’ when the display device is touched against the printer device.

The term ‘electronic paper’ is used herein to refer to display technologies which reflect light (like paper) instead of emitting light like conventional LCD displays. As they are reflective, electronic paper displays do not require a significant amount of power to maintain an image on the display and so may be described as persistent displays. A multi-stable display is an example of an electronic paper display. In some display devices, an electronic paper display may be used together with light generation in order to enable a user to more easily read the display when ambient light levels are too low (e.g. when it is dark). In such examples, the light generation is used to illuminate the electronic paper display to improve its visibility rather than being part of the image display mechanism and the electronic paper does not require light to be emitted in order to function.

The term ‘multi-stable display’ is used herein to describe a display which comprises pixels that can move between two or more stable states (e.g. a black state and a white state and/or a series of grey or colored states). Bi-stable displays, which comprise pixels having two stable states, are therefore examples of multi-stable displays. A multi-stable display can be updated when powered, but holds a static image when not powered and as a result can display static images for long periods of time with minimal or no external power. Consequently, a multi-stable display may also be referred to as a ‘persistent display’ or ‘persistently stable’ display.

The electronic paper displays described herein may be reflective bit-mapped/pixelated displays which provide a 2D grid of pixels to enable, arbitrary content to be displayed.

In various examples, the display devices 106 described below may be described as ‘non-networked displays’ because whilst they can maintain an image without requiring significant power, they have no automatic means of updating their content other than via the method described herein.

The digital data and power bus is described as being contact based and conductive because signals for the digital data and power bus are not provided via a cable (which may be flexible), but instead the display device comprises a plurality of conductive contacts (e.g. metal contacts) on its housing (e.g. on an exterior face of the housing) which can be contacted against a corresponding set of conductive contacts on the housing of a printer device. For example, the plurality of conductive contacts may be on a visible face of the display device (e.g. the front, back or side of the printer device) and may be contacted against a corresponding set of conductive contacts on a visible face of the printer device or within a recess (e.g. a slot) on the printer device, such that an edge of the display device is pushed into the recess so that the contacts on the printer and display devices can make contact with each other. The display device is not permanently connected to a printer device but is, instead, intermittently connected (e.g. hourly, daily, weekly, etc. depending on when new content is desired or available).

A content service, which runs on a computing device which is remote from the display device, receives an identifier (ID) for a printer device and/or a display device, selects content for display based on the received ID and then provides the content to a printer device associated with the received ID (i.e. either the printer device with the received printer ID or the printer device which is in contact with a display device with the received display device ID). The actual content may be pushed to a printer device or alternatively, may be provided in response to a request from the printer device (e.g. in a ‘pull’ operation).

In various examples caching techniques may be used such that the actual content transfer occurs prior to the sensing of the ID. In such an example, the content service may select content based on the received ID and then send an identifier for the content (a content ID) to the printer device which identifies some pre-cached content to be displayed. In various examples machine learning may be used to predict an optimum caching strategy, e.g. if user X usually prints to printers Y and Z, then the content service may cache user X's content on these two printers (ahead of any request for new content from user X) so that printing is faster should user X subsequently dock the display device to printer Y or Z. In another example if user X usually prints to printer Y during the working day and printer Z in the evenings and at weekends, then the content service may cache user X's content on printer Y in a period of time leading up to the start of the working day and then for the working day and then may cache user X's content on printer Z in a period of time leading up to the start of an evening or the weekend. In this way, user X's content may, at some times of day, be cached on both printer Y and Z and at other times of day on only one printer and again this may have the effect that printing is faster when user X subsequently docks the display device to printer Y or Z.

By using such a content service to provide content to a display device (as described above) it may enable a user to browse the history of content that has previously been displayed on a display device (e.g. for possible reuse/annotation) and/or extend searching across all previously printed content (e.g. irrespective of the printer device used to print the content). The content service may facilitate the association of digital content/metadata with the visual image shown on the display device, which can be retrieved from the content service (e.g. on another device, such as a tablet or other computing device), i.e. such that the display device which displays some content acts as a physical representation if (or token for) some virtual/online content (e.g. a Microsoft Word® document, a file stored on a cloud-based server, etc.). The content service may enable user identity related operations such as restricting permissions to the digital content associated with display device (e.g. restricting permissions to other content which is related to the content displayed on the display device). By using a content service, as described herein, remote or automatic updating of the content displayed on the display device may be enabled. Additionally, use of a content service may assist in decoupling the device the user uses to create or edit content (which may, for example, be a smartphone or tablet computer) from the device which writes the content to the display device (the printer device), as both may communicate with the content service rather than requiring these devices to establish direct peer-to-peer connectivity. Use of a content service may also facilitate tracking of the display device or printer device interactions for audit or security purposes. Additionally, use of a content service may enable automated processing of images to optimize how they look on a particular display device technology without the need for the user to install or update any software on a local device, e.g. the content service can upgrade their service at any point, transparently to the user, in order to support new algorithms or new display types.

Furthermore, by using such a content service, the printer device may be less complex (and hence less expensive) and stateless. This means that printers can potentially be widely distributed (e.g. available for anyone to use in public places) and easily replaceable. By virtue of having printers distributed in many locations, content can be more easily place-shifted (e.g. it frees a user from having to transport a complex printer device everywhere). Moving computation off the printers also means that printers can potentially be lower power than a comparable device not using the cloud service described herein. This ensures that printers can operate for longer between battery charges if not mains powered.

From the perspective of the display device, the content service described herein allows a looser coupling between the display device and the printer. It enables the paper to operate similarly regardless of which printer it is attached to. The content service also enables a multi-user environment because users can freely exchange paper devices and use them with their own printers. Also, the user experience is enhanced because with the content service the system can give the illusion of the paper being a complete device rather than an accessory to a printer.

Furthermore, by using a content service as described herein, content that needs to be printed on electronic paper display devices travels through a single point. This allows aggregate statistics about participating devices to be generated. For instance, which printers are most frequently used, which electronic paper display devices may be reaching the end of their rated life-span, detecting faults, etc.

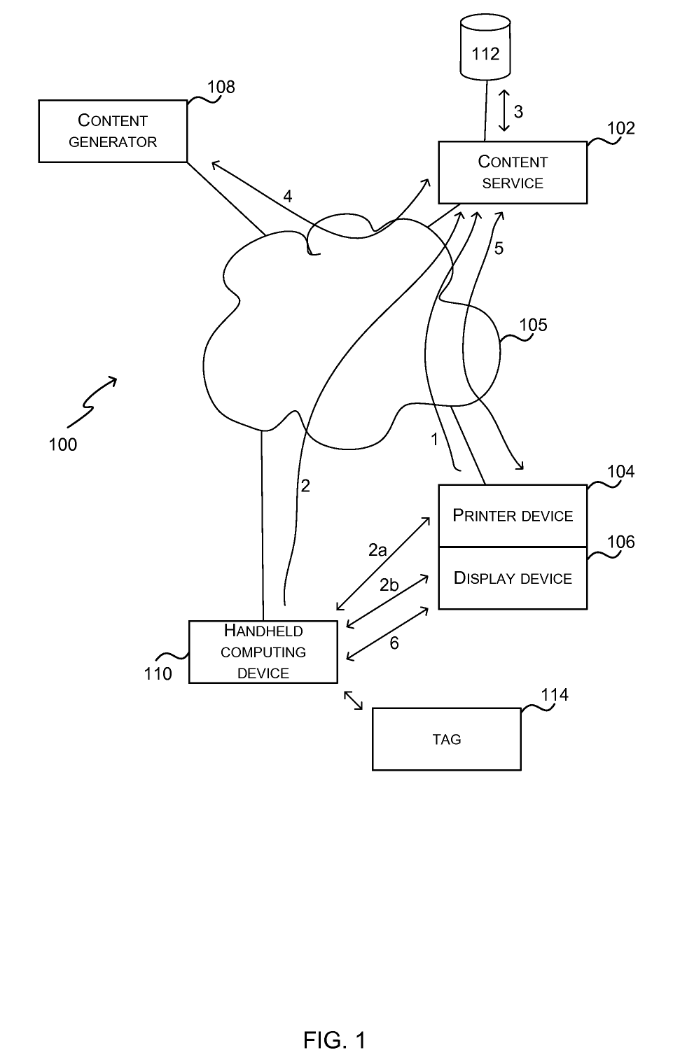

FIG. 1 is schematic diagram of an example system 100 which comprises the content service 102 and a printer device 104 which can communicate via a network 105 (e.g. the internes). The system 100 also comprises a content generator device 108 which provides the content which is transmitted to the printer device 104 by the content service 102 and in some examples, the content service 102 may also act as the content generator device 108. The system further comprises a display device 106 which can be brought into contact with the printer device 104.

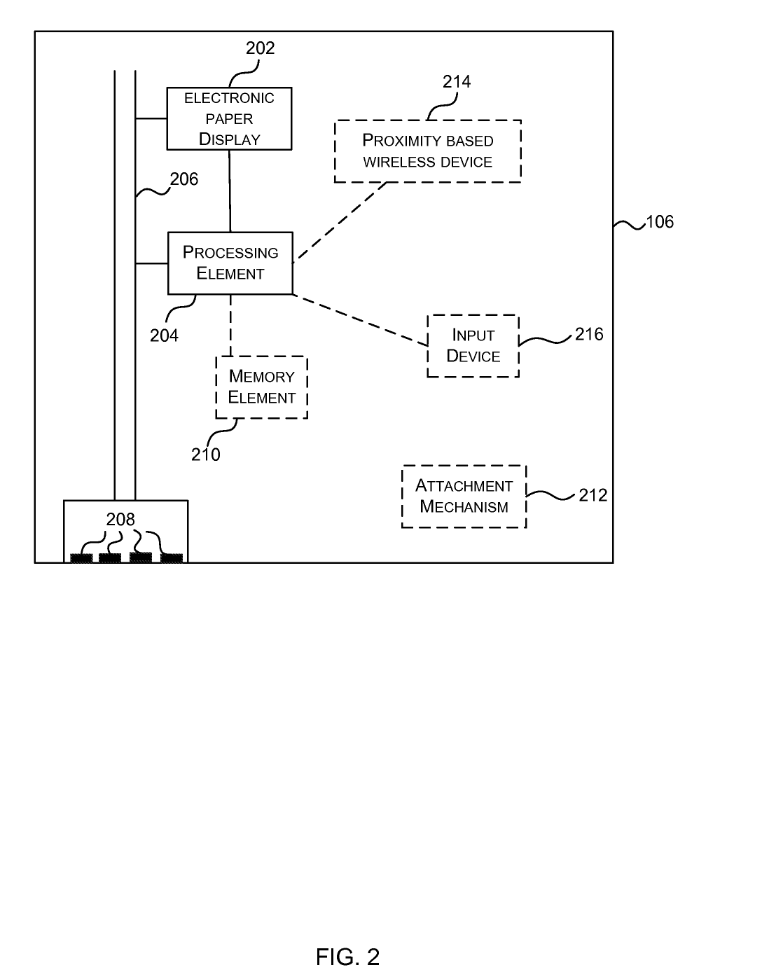

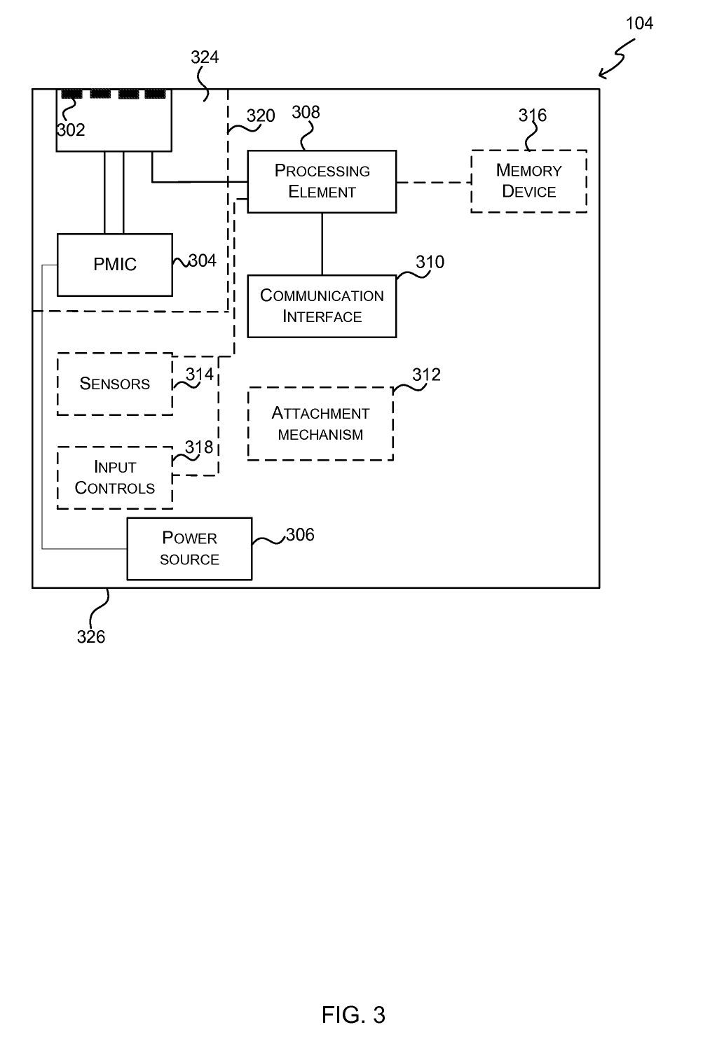

FIG. 2 is a schematic diagram showing the display device 106 in more detail and FIG. 3 is a schematic diagram showing the printer device 104 in more detail.

The display device 106 comprises an electronic paper display 202, a processing element 204 and a contact based conductive digital data and power bus 206. As described above, the bus 206 connects the processing element 204 to a plurality of conductive contacts 208 on the exterior of the housing of the display device 106. The display device 106 does not comprise a power source capable of updating the electronic paper display and power for updating the electronic paper display is instead provided via the bus from a power source 306 in the printer device 104.

The electronic paper display 202 may use any suitable technology, including, but not limited to: electrophoretic displays (EPDs), electro-wetting displays, bi-stable cholesteric displays, electrochromic displays, MEMS-based displays, etc. and some of these technologies may provide multi-stable displays. In various examples, the display has a planar rectangular form factor; however, in other examples the electronic paper display 202 may be of any shape and in some examples may not be planar but instead may be curved or otherwise shaped (e.g. to form a wearable wrist-band). In various examples, the electronic paper display 202 may be formed on a plastic substrate which may result in a display device 106 which is thin (e.g. less than one millimeter thick) and has some flexibility. Use of a plastic substrate makes the display device 106 lighter, more robust and less prone to cracking of the display (e.g. compared to displays formed on a rigid substrate such as silicon or glass).

The processing element 204 may comprise any form of active (i.e. powered) sequential logic (i.e. logic which has state), such as a microprocessor, microcontroller, shift register or any other suitable type of processor for processing computer executable instructions to drive the electronic paper display 202. The processing element 204 comprises at least the row & column drivers for the electronic paper display 202; however, in various examples, the processing element 204 comprises additional functionality/capability. For example, the processing element 204 may be configured to demultiplex data received via the bus 206 and drive the display 202.

In various examples the processing element 204 may comprise one or more hardware logic components, such as Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs) and Graphics Processing Units (GPUs).

In various examples, the processing element 204 may comprise (or be in communication with) a memory element 210 which is capable of storing data for at least a sub-area of the display 202 (e.g. one row and column of data for the display 202) and which in some examples may cache more display data. In various examples the memory element 210 may be a full framebuffer to which data for each pixel is written before the processing element 204 uses it to drive the row/column drivers for the electronic paper display. In other examples, the electronic paper display may comprise a first display region and a second display region which may be updated separately (e.g. the second display region may be used to show icons or user-specific content) and the memory element may be capable of storing data for each pixel in one of the display regions.

In various examples, the memory element 210 may store other data in addition to data for at least a sub-area of the display 202 (e.g. one row and column of the display). In various examples, the memory element 210 may store an identifier (ID) for the display device 106. This may be a fixed ID such as a unique ID for the display device 106 (and therefore distinct from the IDs of all other display devices 106) or a type ID for the display device (e.g. where the type may be based on a particular build design or standard, electronic paper display technology used, etc.). In other examples, the ID may be a temporary ID, such as an ID for the particular session (where a session corresponds to a period of time when the display device is continuously connected to a particular printer device) or for the particular content being displayed on the display device (where the ID may relate to a single page of content or a set of pages of content or a particular content source). In various examples, a temporary ID may be reset manually (e.g. in response to a user input) or automatically in order that a content service does not associate past printout events on a display device with current (and future) printouts, e.g. to disable the ability for a user to find out the history of what was displayed on a display device which might, for example, be used when the display device is given to another user. The ID which is stored may, for example, be used to determine what content is displayed on the display device and/or how that content is displayed (as described in more detail below).

In various examples, the memory element 210 may store parameters relating to the electronic paper display 202 such as one or more of: details of the voltages (or voltage levels) required to drive it (e.g. the precise value of a fixed common voltage, V_{com}, which is required to operate the electronic paper display), the size and/or the resolution of the display (e.g. number of pixels, pixel size or dots per inch, number of grey levels or color depth, etc.), temperature compensation curves, age compensation details, update algorithms and/or a sequence of operations to use to update the electronic paper display (which may be referred to as the ‘waveform file’), a number of update cycles experienced, other physical parameters of the electronic paper display (e.g. location, orientation, position of the display relative to the device casing or conductive contacts), the size of the memory element, parameters to use when communicating with the electronic paper display, etc. These parameters may be referred to collectively as ‘operational parameters’ for the electronic paper display. The memory element 210 may also store other parameters which do not relate to the operation of the electronic paper display 202 (and so may be referred to as ‘non-operational parameters’) such as a manufacturing date, version, a color of a bezel of the display device, etc.

Where the memory element 210 stores an ID or parameters for the electronic paper display, any or all of the stored ID and parameters may be communicated to a connected printer device 104 via the bus 206 and contacts 208 by the processing element 204. The printer device 104 may then use the data received to change its operation (e.g. the voltage levels provided via the bus or the particular content provided for rendering on the display) and/or to check the identity of the display device 106. The ID may in addition, or instead, be communicated to the content service 102 as described in more detail below.

In various examples, the memory element 210 may store computer executable instructions which are executed by the processing element 204 (when power is provided via the bus 206). The memory element 210 includes volatile and non-volatile, removable and non-removable computer storage media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media.

In various examples, the display device 106 may further comprise an attachment mechanism 212 which is configured to hold the display device 106 in contact with a printer device when a user has brought the two devices into contact with each other. This attachment mechanism 212 may, for example, use one or more ferromagnetic elements in one or both of the display device 106 and the printer device 104. In addition to, or instead of, using ferromagnetic elements, the attachment mechanism may use suction cup tape, friction (e.g. with the display device being partially inserted into a slot or recess on the printer device) or a clamping arrangement.

In various examples, the display device 106 may further comprise a proximity based wireless device 214, such as a near field communication (NFC) device. The proximity based wireless device 214 comprises a data communication interface (e.g. an I²C interface, SPI, an asynchronous serial interface, etc.) and an antenna and may also comprise a memory device. The memory may be used to store an identifier (ID) which may be fixed or dynamic (or may comprise a fixed element and a dynamic element which may be stored in the same memory device or separately) and which may be read (via the antenna) by another proximity based wireless device which is in proximity to the display device 106 (e.g. an NFC reader which may be integrated within a handheld computing device 110 or printer device 104). The ID may comprise one or more elements: an element that is fixed and correspond to an ID for the display device 106 and/or an element that is dynamic and correspond to the content currently being displayed on the display device 106 or a current session/instance ID (i.e. it may be a fixed device ID or a dynamic content ID). Where the ID (or part thereof) is a content ID or an instance ID, this may be written by the processing element 204 whenever new content is rendered on the display. Where the ID is a session ID, this may be written by the processing element 204 at the start of each new session (e.g. when the processing element switches on). In other examples, the memory may be used to store operational parameters for the display device (e.g. as described above).

Where the display device 106 comprises a proximity based wireless device 214, this wireless device is not used to provide power to update the electronic paper display (i.e. energy harvesting is not used to provide power to update the electronic paper display).

In various examples, the display device 106 may further comprise one or more input devices 216. An input device 216 may, for example, be a sensor (such as a microphone, touch sensor or accelerometer) or button. Such input devices 216 are only operational (i.e. powered) when the display device 106 is in contact with a printer device 104 such that power is provided via the bus 206. Where the display device 106 comprises an input device 216, signals generated by the input device 216 may be interpreted by the processing element 204 and/or communicated to a remote processing device (e.g. in a printer device 104). User inputs via an input device 216 may, for example, be used to modify the content displayed on the electronic paper display 202 (e.g. to annotate it, change the font size, trigger the next page of content to be displayed, etc.) or to trigger an action in a remote computing device.

In an example, the display device 106 comprises an input device 216 which is a touch-sensitive overlay for the electronic paper display 202. The touch-sensitive overlay may, for example, use pressure, capacitive or resistive touch-sensing techniques. When the display device 106 is powered via the bus (i.e. when it is in contact with a printer device 104), the touch-sensitive overlay may be active and capable of detecting touch events (e.g. as made by a user's finger or a stylus touching the electronic paper display 202). The output of the touch-sensitive overlay is communicated to the processing element 204 or printer device (104) or content service which may modify the displayed image (on the electronic paper display 202) to show marks/annotations which correspond to the touch events. In other examples, the processing element 204 may modify the displayed image in other ways based on the detected touch-events (e.g. through the detection of gestures which may, for example, cause a zoom effect on the displayed content).

In another example, the display device 106 comprises an input device 216 which is a microphone. The microphone detects sounds, including speech of a user and these captured sounds may be detected by the processing element 204 or printer device or content service and translated into changes to the displayed image (e.g. to add annotations or otherwise change the displayed content). For example, simple keyword detection may be performed on the processing element to cause it to fetch content from memory and write it to the electronic paper display. In another example, the processing element may interpret or transform the audio data and ship it out to the printer device or a remote server for more sophisticated processing. In another example, the recorded sounds (e.g. speech waveform) may be recorded and stored remotely (e.g. in a content service) associated with the ID of the display device and a visual indication may be added to the displayed content so that the user knows (e.g. when they view the same content later on) that there is an audio annotation for the content.

In various examples, the display device 300 may comprise a touch-sensitive overlay and a microphone which operate in combination to enable a user to use touch (e.g. with a finger or stylus) to identify the part of an image (or other displayed content) to annotate and then their voice to provide the annotation (as captured via the microphone). In such an example, the spoken words may be text to add to the displayed content or commands (e.g. “delete this entry”).

The printer device 104 comprises a plurality of conductive contacts 302 and a power management IC (PMIC) 304 which generates the voltages (or voltage levels) that are provided to bus of the display device (via contacts 302). The PMIC 304 is connected to a power source 306 which may comprise a battery (or other local power store, such as a fuel cell or supercapacitor) and/or a connection to an external power source. Alternatively, the printer device 104 may use an energy harvesting mechanism (e.g. a vibration harvester or solar cell).

The printer device 104 further comprises a processing element 308 which provides the data for the bus of the display device, including the pixel data. The processing element 308 in the printer device 104 obtains content for display from the content service 102 via a communication interface 310 and may also obtain one or more operational parameters for different display devices from the content service 102. The communication interface 310 may use any communication protocol and in various examples, wireless protocols such as Bluetooth™ or WiFi™ or cellular protocols (e.g. 3G or 4G) may be used and/or wired protocols such as USB or Ethernet may be used. In some examples, such as where the communication interface uses USB, the communication interface 310 may be integrated with the power source 306 as a physical connection to the printer device 104 may provide both power and data.

The processing element 308 may, for example, be a microprocessor, controller or any other suitable type of processor for processing computer executable instructions to control the operation of the printer device in order to output pixel data to a connected display device 106. In some examples, for example where a system on a chip architecture is used, the processing element 308 may include one or more fixed function blocks (also referred to as accelerators) which implement a part of the method of providing pixel data in hardware (rather than software or firmware). The processing element 308 may comprise one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

The printer device 104 may comprise an attachment mechanism 312, such as one or more ferromagnetic elements or a slot to retain the display device. This attachment mechanism 312 may, in various examples, incorporate a sensor 314 (which may be implemented as a sensing electronic circuit) to enable the printer device 104 to determine the orientation of a display device when in contact with the printer device 104 and/or whether a display device is in contact or not.

In various examples, the processing element 308 may comprise (or be in communication with) a memory device (or element) 316. In various examples, the memory element 316 may store an identifier (ID) for the printer device 104. This may be a fixed ID such as a unique ID for the printer device 104 (and therefore distinct from the IDs of all other printer devices 104) or a type ID for the printer device (e.g. where the type may be based on a particular build design or standard, etc.). In other examples, the ID may be a temporary ID, such as an ID for the particular session (where a session corresponds to a period of time when the display device is continuously connected to a particular printer device) or for the particular content being displayed on a connected display device (where the ID may relate to a single page of content or a set of pages of content or a particular content source).

In various examples, the memory element 316 may store operational parameters for one or more different electronic paper displays, where these operational parameters may be indexed (or identified) using an ID for the display device (e.g. a unique ID or a type ID). Where operational parameters are stored in the memory element 316 these may be copies of parameters which are stored on the display device, or they may be different parameters (e.g. voltages may be stored on the display device and a waveform for driving the display device may be stored on the printer device because it occupies more memory than the voltages) or there may not be any operational parameters stored on the display device. In addition, or instead, the memory element may store parameters associated with printer device, such as its location (e.g. kitchen, bedroom, etc.) and additional connected devices (e.g. a music player through which audio can be played, etc.).

In various examples, the memory element 316 may act as a cache for the content (or image data) to be displayed on a connected display device. This may, for example, enable content to be rendered more quickly to a connected device (e.g. as any delay in accessing the content service 102 may be hidden as pages are cached locally in the memory element 316 and can be rendered whilst other pages are being accessed from the content service 102) and/or enable a small amount of content to be rendered even if the printer device 104 cannot connect to the content service 102 (e.g. in the event of connectivity/network problems).

The memory element 316 may, in various examples, store computer executable instructions for execution by the processing element 308. The memory element 316 may include volatile and non-volatile, removable and non-removable computer storage media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 316) is shown within the printer device 104 it will be appreciated that the storage may be distributed or located remotely and accessed via a network or other communication link (e.g. using communication interface 310).

As described above, the printer device 104 may comprise a sensor 314 configured to detect whether a display device is in contact with the printer device 104 or is electrically connected via the contacts 302. In addition or instead, one or more other sensors may be provided within the printer device 104, such as an accelerometer (e.g. for sensing motion of or the orientation of the printer device 104) and/or a sensor for detecting a proximate handheld computing device (e.g. a smartphone or tablet computer).

In various examples, the printer device 104 may comprise one or more user input controls 318 which are configured to receive user inputs. These user inputs may, for example, be used to change what is displayed on a connected display device (e.g. to select the next page within a piece of content or the next piece of content). For example, the printer device 104 may comprise one or more physical buttons. In various examples, one or more physical buttons may be provided which are mapped to specific content (e.g. when pressing a particular button, a photo ID badge will always be rendered on the connected display). These buttons may have fixed functions or their functions may change (e.g. based on the content displayed or the display device connected). In some examples, the processing element 308 may render icons adjacent to each button on the electronic paper display, where an icon indicates the function of the adjacent button. In such an example, the pixel data provided to the display device (via contacts 302) is a composite image which combines the content to be displayed and one or more icons for buttons (or other physical controls) on the printer device 104. In other examples, the composite image may be generated by the content service 102.

In an example, the printer device 104 comprises an input control (or device) 318 which detects a user touching a connected display device with their finger or a stylus. This may, for example, comprise an electromagnetic sensing backplane (e.g. using electric field sensing) in the face of the printer device which is adjacent to a connected display device or may be implemented using force sensors (e.g. four sensors at the corners and where interpolation is used to calculate the touch point position) or active digitizer pens. Alternatively, optical or ultrasonic methods may be used (e.g. to look along the top surface). Where ultrasonic transducers are used, these may additionally be used to provide haptic feedback to the user. The output of the touch input control is communicated to the processing element 308 or to the content service which may modify the content and then provide the modified content to the display device (so that it is displayed on the electronic paper display 106) to show marks/annotations which correspond to the touch events. In other examples, the processing element 308/content service may modify the displayed image in other ways based on the detected touch-events (e.g. through the detection of gestures which may, for example, cause a zoom effect on the displayed content or through provision of feedback in other ways, e.g. using audio or vibration or by selectively backlighting the electronic paper display using one or more lightpipes).

In various examples, the printer device 104 comprises an input device which is a microphone. The microphone detects sounds, including speech of a user and these captured sounds may be detected by the processing element or content service and translated into changes to the displayed image (e.g. to add annotations or otherwise change the displayed content). In another example, the recorded sounds (e.g. speech waveform) may be recorded and stored remotely (e.g. in a content service) associated with the ID of the display device and a visual indication may be added to the displayed content so that the user knows (e.g. when they view the same content later on) that there is an audio annotation for the content.

The input control on the printer device may comprise NUI technology which enables a user to interact with the printer device and/or display device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, RGB camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

In various examples, the printer device 104 may comprise a sensing backplane and a microphone which operate in combination to enable a user to use touch (e.g. with a finger or stylus) to identify the part of an image (or other displayed content) to annotate and then their voice to provide the annotation (as captured via the microphone). In such an example, the spoken words may be text to add to the displayed content or commands (e.g. “delete this entry”).

The printer device 104 may have many different form factors. In various examples it is standalone device which comprises a processing element 308 and communication interface 310 in addition to a PMIC 304 and a plurality of conductive contacts 302 to provide the signals for the digital data and power bus 206 within a display device. In other examples, however, it may be a peripheral for a computing device and may utilize existing functionality within that computing device which may, for example, be a portable or handheld computing device (e.g. a smartphone, tablet computer, handheld games console, etc.) or a larger computing device (e.g. a desktop computer or non-handheld games console). Where the printing device 104 is implemented as a peripheral device, the functionality shown in FIG. 3 may be split along the dotted line 320 such that the PMIC 304 and conductive contacts 302 are within the peripheral 324 and the remaining elements (in portion 326) are within the computing device and may utilize existing elements within that computing device. In further examples, the entire printer device 104 may be integrated within a computing device.

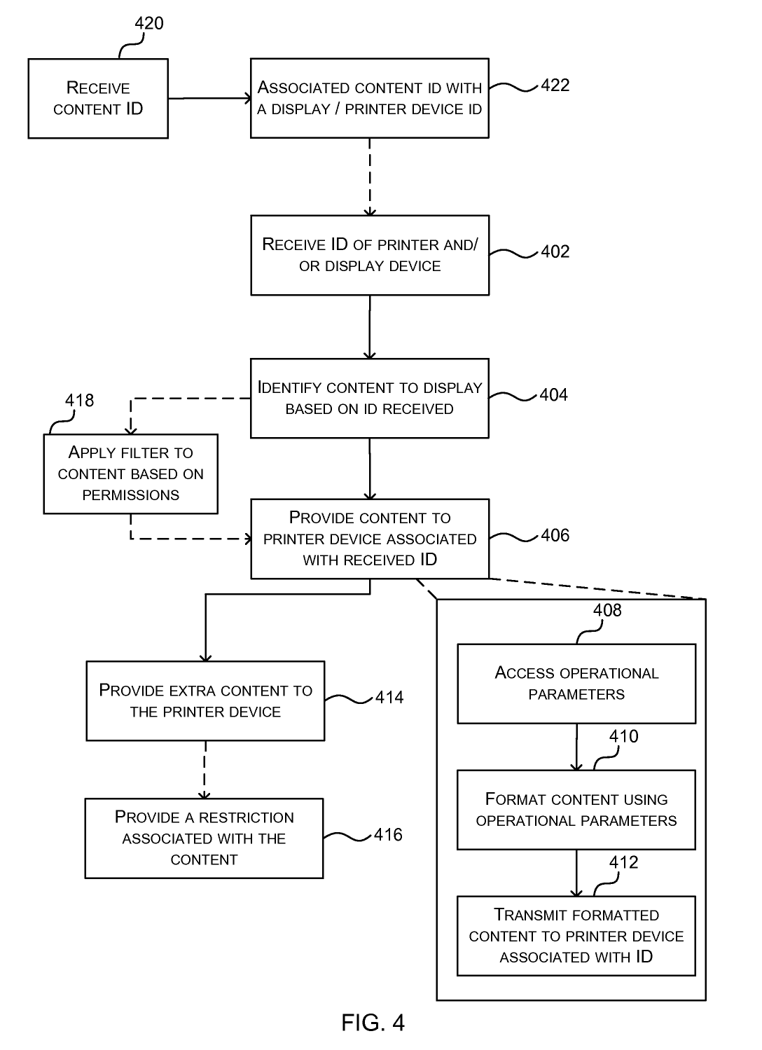

FIG. 4 is a flow diagram showing an example method of operation of the content service 102 shown in FIG. 1. The method comprises receiving an identifier (ID) of a printer device or a display device (block 402). This ID may be received from a printer device 104 (arrow 1 in FIG. 1) or from a separate computing device, e.g. handheld computing device 110 (arrow 2 in FIG. 1).

Where the ID is received from the printer device 104 (arrow 1) this ID may be the ID of the printer device (e.g. as stored in memory element 316) or the ID of a connected display device 106 (e.g. as stored in memory element 210 and read by the printer device 104 via the contacts 208 or as stored within a memory associated with the proximity based wireless device 214 and read by a reader for such a device in the printer device).

Where the ID is received from a separate computing device 110 (arrow 2) this ID may be the ID of the printer device (e.g. as stored in memory element 316 and read from the printer device in some way (arrow 2a), such as via proximity based wireless device in the printer device) or the ID of a display device 106 (e.g. as stored within a memory associated with the proximity based wireless device 214 and read by a reader for such a device in the separate computing device 110, arrow 2b). Where the proximity based wireless device 214 is used, the display device 106 may or may not be connected to a printer device 104 at the time the ID is read by the separate computing device 110.

In a further example, a printer device ID may be read from a proximity based wireless device 214 in a display device 106. This printer device ID may be the ID of the last printer to which the display device 106 connected and may have been written to the proximity based wireless device 214 by the processing element 204. Alternatively, the printer device ID may be the ID of a default or ‘home’ printer device for the display device.

In various examples, additional information may be received along with the IDs (in block 402), such as one or more operational parameters for a display device and/or printer device, a content ID, contextual information associated with the request for new content (e.g. that the request was made due a user pressing a button on the display device or the printer device) etc. and this is described in more detail below.

In response to receiving an ID (in block 402), the content service 102 selects content to provide to the printer device based on the ID received (block 404). The content may be termed new content as it is content that is different from the content currently being displayed, (i.e. the term ‘new’ in this context does not refer to the age of the content or whether it has previously been displayed or not). This may happen immediately after receiving the ID or there may be a delay between receiving the ID (in block 402) and selecting content to write (in block 404). The content which is identified may be stored in a local content store 112 (arrow 3 in FIG. 1) or may be accessed from a content generator device 108 (arrow 4 in FIG. 1).

In various examples, a printer device 104 may provide content to a connected display device 106 which is the same irrespective of which particular display device is connected. For example a printer device 104 may provide pixel data for a current weather forecast, news update, etc. to any display device 106 which is connected to it. In such examples, the printer device 104 may regularly poll the content service 102 for updated content (e.g. by sending its ID to the content service) or the content service 102 may automatically push updated content to the printer device periodically (e.g. every day or every hour) or when updated content is available (e.g. in the event of a news flash or each time a news feed is updated by the content generator device 108).

In other examples, content may be identified with a display device 106, such that a display device can receive its content irrespective of which particular printer device it connects to. In such examples, when a display device 106 is connected to a printer device 104, the printer device 104 may send the ID of the connected display device to the content service 102 in order to request any new content which is available for that display device.

In some examples, the content service may receive both a printer device ID and a display device ID (in block 402) and in such examples, the content which is identified (in block 404) may be identified using either or both of the IDs received. For example, the content associated with the identified display device may be filtered based on the ID of the printer device to which it is connected. This may, for example, be used to limit the access to some content to certain locations (e.g. only those printer devices within a particular corporation or firewall and not those printer devices in public or home locations). In other examples, other contextual metadata (which may be received by the content service 102 in block 402) may be used to filter the available content or otherwise influence what content is available (in block 404). This may, for example, include sensor data from a sensor 314 in the printer device 104 or orientation data for the display device or the size and/or shape of the particular display device, or data identifying the trigger for the printer request, etc.

In various examples, data identifying the trigger for the printer request may be sent for every request and received by the content service along with an ID (in block 402). In such examples, a number of different trigger modes may be implemented and various examples are described below.

a) Triggers causing a specific content item to be shown, no matter which printer or display device is used (this may, for example, be used by museums or other organizations to show content that is meant to be widely accessible/not personalized such as the opening hours of various exhibits that day).
b) Triggers which show a specific image customized to a particular display device, e.g. the “Blank” image which for a display device with a black bezel is mostly black.
c) Triggers which are specific to a printer device—this causes pre-defined content to be displayed (e.g. content may be stored against different buttons on a printer device and then when a user presses a particular button, the content which has been stored associated with that button is rendered on an attached display device).
d) Triggers which act as “next page”, “previous page” etc. for multi-page content items, and “next document”, “previous document” for session-based navigation. In various examples the permissions may be set such that the former are always accessible—any printer can show all the pages of an active document on a display device even if it has never been attached to the paper before. However, for the latter, sessions are reset every time a display device is detached and so a user can only navigate back through content within a session.
e) Triggers sent when a display device is attached or when the display device is removed. The attachment of a display device can for example cause a re-writing of the content to the display device and this may, for example, be implemented so that if displayed images ever become corrupted or out of sync with the content service, they automatically re-sync when next attached to a printer. The display device removed event clearly cannot cause new content to be transmitted for printing (as there is no attached display device) but it is used as context for future print events (e.g. it bounds a session of use).
f) Triggers sent when any button is pressed on the printer, where the content service is responsible for implementing a state machine or logic to decide what content should now be sent (e.g. the printer device can send “button three” and the content service could infer that this means “next page” rather than the printer itself).
g) Triggers sent to poll for new content, when no other trigger is currently active. This trigger is the one that the cloud service may typically delay its response to, as long as it determines that the content which should be on a display has not changed.

In an example where the ID is received (in block 402) from a computing device 110 and not from a printer device 104, the content may also be provided by that computing device. For example, a user may read the ID of a display device (e.g. using a proximity based wireless device reader in a handheld computing device such as a tablet or smartphone) and identify the content that they wish to have displayed on that display device (this may, for example, be the latest screen grab or the content currently being displayed on the screen). The handheld computing device 110 may then send the ID and content data (e.g. the content itself or a link to the content) to the content service (in block 402, arrow 2) so that the content service 102 can provide the content data to a printer device when the particular display device is contacted against it.

Where new content is identified (in block 404), this is then provided to the printer device which is associated with the ID received (block 406, arrow 5 in FIG. 1). For example, where a printer device ID is received (in block 402), the content is transmitted to the printer device with that ID (in block 406); however, where a display device ID is received (in block 402) and a printer device ID is not received, the content may be transmitted (in block 406) to a printer device to which the identified display device is connected or to a printer device which is otherwise associated with the display device ID (e.g. a default or ‘home’ printer device for the identified display device). The content service 102 may store a list of mappings between display device IDs and printer device IDs and this may be used in determining a printer device which is associated with a received display device ID. In various examples, this list of mappings may be updated each time a display device is contacted against a display device such that it lists the last printer device that a display device was connected to or the printer device that the display device connects to most often.

Content may be transmitted (in block 406) one page at a time; although pages of content may be provided ahead of the time that they are required and cached by a printer device. Where the content cannot fit on a single page, the content service 102 may divide the content into a plurality of pages and associate multiple pages (i.e. multiple screenfuls) of related context together.

When providing the content to a printer device (in block 406), the content service 102 may access one or more operational parameters for the display device 106 on which the content is to be displayed (block 408). These operational parameters may be stored within the content service 102 and/or an associated data store 112 and/or may be received along with the ID(s) (in block 402) or may be accessed from a remote source using the IDs received. The content is then formatted using the operational parameters (block 410) before being transmitted to a printer device associated with the received ID (block 412). The formatting of the content (in block 410) may, for example, comprise resizing the data for the particular display device size, resolution or orientation (where the orientation data may be provided by the printer device and detected by a sensor 314 in the printer device), splitting it into multiple pages (as described above), performing image processing on the content to improve the quality of the displayed content on the particular display device, etc. In some examples, the formatting of the content (in block 410) may also be based on aesthetic aspects (e.g. such as the color of the bezel of the display device, so that, for example, the background of the displayed image matches the bezel of the display). The color of a bezel may be a non-operational parameter (as it does not affect the operation of the display device, as described above) and this parameter may be stored on the display device and/or an associated data store and/or on the display device itself.

In some examples a user identifier (ID) may also be received by the content service 102 (in block 402) and the formatting (in block 410) may be based, at least in part, on one or more user preferences which are associated with the received user ID, e.g. to provide a personalized border around the content, a preferred font and/or font size for the user ID, etc.

In addition, or instead, when providing the content to a printer device (in block 406), the content service 102 may access one or more operational parameters for the printer device 104 (block 408). These operational parameters may be stored within the content service 102 and/or an associated data store 112 and/or may be received along with the ID(s) (in block 402) or may be accessed from a remote source using the IDs received. The content is then formatted using the operational parameters (block 410) before being transmitted to a printer device associated with the received ID (block 412). The operational parameters may, for example, identify the location of any physical controls 318 (e.g. buttons) on the printer device and the formatting of the content (in block 410) may comprise forming a composite image from the content itself and icons for the physical controls, with the icons being placed within the content such that they appear adjacent to the button when the display device is connected to the printer device. The content service 102 may be able to determine the function associated with one or more of the buttons (e.g. based on the content being displayed, user preferences, etc.) or these functions may be fixed. Where the functions are determined by the content service 102, information about the functions may be provided to the printer device 104 (in block 412 along with the formatted content) so that the printer device 104 can correctly respond to a user input or user inputs via the buttons may be communicated to and interpreted by the content service 102.

In other examples, a composite image may be used to combine other information with the content to be provided, e.g. user input such as annotations (as described above), notifications (e.g. which may be overlaid on other content or displayed alongside other content).

In various examples, the content service 102 may provide additional, non-display content to the printer device along with the content (block 414). This additional information may be supplementary to the content which is to be displayed on the display device 106 and which may be written to the proximity based wireless device 214 on the display device 106 by the printer device 104 (e.g. via the bus 206 and processing element 204). This additional information may subsequently be read by a proximity based wireless device reader in another computing device (e.g. handheld computing device 110, arrow 6 in FIG. 1) and used to render additional content on the computing device which is associated with the content displayed on the display device 106. In an example, the additional content may be a link (e.g. a URL) to an interactive version of the content or to supplemental information or to a version of the content which is more suited to an active display (e.g. a display which is not an electronic paper display such as an LED or LCD display). Other examples of additional content may include dictionary definitions of uncommon words or links to such definitions, links to related articles or where to buy items mentioned, other photographs of the same place (by other people) as is shown in displayed content, names of people in photos and/or metadata for those people (e.g. contact details), names of landmarks, etc. The additional content may be provided by the content generator device 108 or may be a link to the content generator device itself. In other examples the additional content may be generated by the content service 102 itself, e.g. by performing OCR (optical character recognition) on the content provided (in block 406) or otherwise data mining the content in any way (e.g. pattern matching, image recognition, etc.).

In an example, the provision of this additional, non-display content may enable a user to access the content on a second display on a separate device (e.g. an active display on a computing device), to annotate the content and then push the annotated content back to the content service 102 so that it be displayed on the electronic paper display in the display device 106.

In various examples, the content service 102 may receive an identifier (ID) for a particular piece of content (in block 420) and in response, the content service 102 associates the content ID with a printer or display device (block 422). This stored association between a content ID and a printer and/or display device ID (generated in block 422) may then subsequently be used upon receipt of a printer and/or display device ID (in block 402) to identify new content to display (in block 404). In various examples, the content ID may be received with a printer/display device ID (in block 420) and in such a case, the association generated (in block 422) is between the received content ID and the received printer/display device ID. In various examples, the stored association may be removed or invalidated once the content corresponding to the content ID has been provided to a printer device (in block 406). In addition, in various examples, the stored association may have a finite lifetime, such that it is removed or invalidated at the end of its defined lifetime even if the content has not yet been provided to a printer device.

For example, a handheld computing device 110 may read a display device ID from a proximity based wireless device 214 in the display device 106 and a content ID from a tag 114 in the environment. This tag 114 may, for example, be a proximity based wireless tag (e.g. an NFC tag), a QR code, an RFID tag, etc. The handheld computing device 110 may then transmit both IDs to the content service 102 (received in block 420, arrow 2 in FIG. 1). The tag 114 may reference a fixed piece of content (e.g. details about a particular product, where the tag is affixed to the product or the product packaging) or dynamic content (e.g. the current weather or news). The content service 102 then stores the association between the received display device ID and the content ID (in block 422) so that when the display device is subsequently in contact with a printer device, the content identified by the content ID can be provided to the printer ID for transmission to the display device. Alternatively, the handheld computing device 110 may read a printer device ID instead of a display device ID (e.g. from a printer device). Similarly, a tag 114 in the environment may be read by a printer device 104 instead of a handheld computing device.

In another example, a display device may store content IDs for recently viewed content to enable a user to step backwards and forwards through recently displayed content whilst connected to a printer device. In some examples, the list of content IDs for recently viewed content may be stored in volatile memory such that it is lost when the display device is removed from a printer device (and power is lost). This use of volatile memory acts as a security feature because another user cannot pick up the display device, connect it to a printer device and then scroll through recently viewed content (which may include sensitive or personal data).

In addition to providing the content to a printer device (in block 406), the content service 102 may also provide restrictions relating to the content (block 416). An example restriction may specify when the content should be stop being displayed on a display device and these restrictions may be written by the printer device to the display device (e.g. to memory element 210 or proximity based wireless device 214) so that they can be subsequently retrieved by a printer device and acted upon. For example, an expiry date/time for the currently displayed content may be stored in the display device and this may be checked as soon as the display device is connected to a printer device. If the expiry date/time has passed, the display device may automatically be cleared (e.g. set to a blank screen by the processing element within the display device or the printer device) even if a user does not trigger a content update via the printer device.

In addition to, or instead of, transmitting the restriction to a printer device for implementation on the printer device and/or the display device, the content service 102 may apply the restrictions to the content, e.g. by applying a filter to the content based on permissions associated with the content (block 418). The filter may be applied at any stage in the process, for example prior to providing content to a printer device (e.g. between blocks 404 and 406 and/or prior to or as part of block 414) or after providing content to a printer device (e.g. after block 406 and before block 414, where the extra content provided in block 414 may be content which overwrites/obscures expired content). Referring back to the example of an expiry date/time described above, the expiry date/time may be retained and monitored by the content service itself such that once the date/time has passed, the content service sends blanking content (e.g. a blank or default page) to a printer device to which the display device showing the expired content is connected.

In various examples, the content service 102 may comprise a rules engine to determine what content to provide (in block 406) in the event of a conflict. For example, a printer ID and a display ID may be received (in block 402) and based on these IDs, more than one item of content may be identified (in block 404) or the current content on a display device may have been updated (off the display device, e.g. the weather forecast) but in addition there may be another request (e.g. triggered by time of day or a manual request by the user) to show different content. The rules engine may therefore perform conflict resolution and determine which piece of identified content is transmitted first (in block 406) and/or the order of any subsequent pieces of content to be transmitted. In such an example, additional extra content may be provided (in block 414) in the form of content IDs for the content which was not prioritized by the rules engine and this may enable a user to quickly select the next piece of content.

The content service 102 may be implemented on a server in a data center (e.g. a ‘cloud-based’ server) or may be implemented across a plurality of highly distributed, but smaller data centers (e.g. micro data centers or cloudlettes). In other examples the content service 102 may be implemented on the content generator device 108 or on a user computing device.

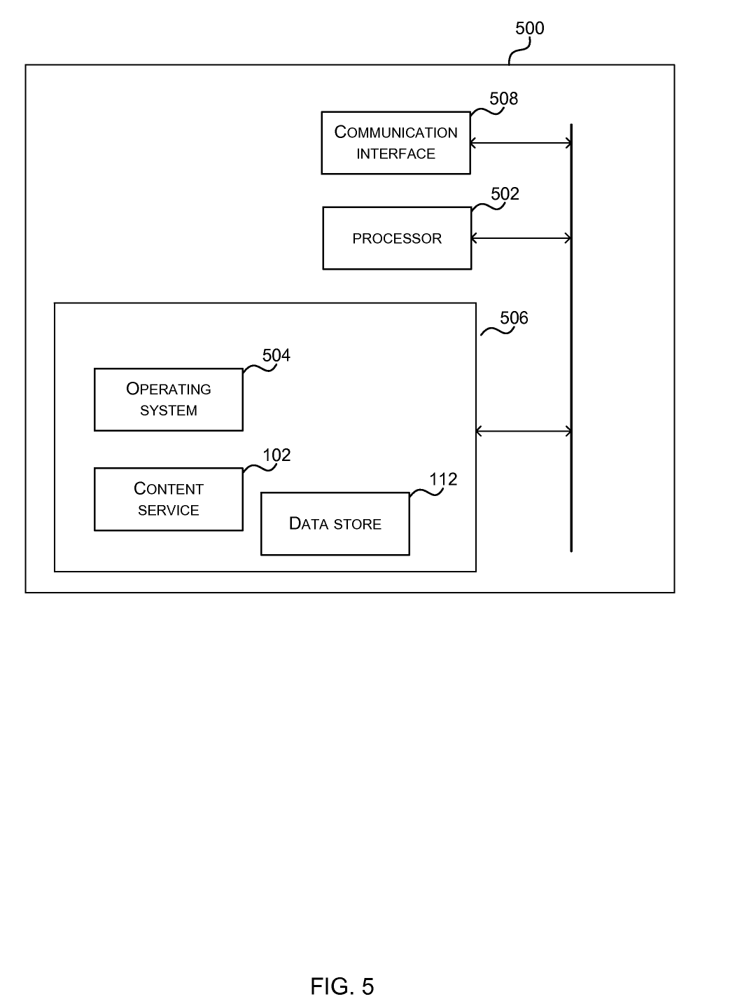

FIG. 5 illustrates various components of an exemplary computing-based device 500 which may be implemented as any form of a computing and/or electronic device, and which may run the content service 102 described herein.

Computing-based device 500 comprises one or more processors 502 which may be microprocessors, controllers or any other suitable type of processors for processing computer executable instructions to control the operation of the device in order to provide the content service 102. In some examples, for example where a system on a chip architecture is used, the processors 502 may include one or more fixed function blocks (also referred to as accelerators) which implement a part of the method of operation of the content service 102 in hardware (rather than software or firmware), e.g. to format the content (in block 410) or identify extra content (in block 414). Platform software comprising an operating system 504 or any other suitable platform software may be provided at the computing-based device to enable application software, including the content service 102, to be executed on the device. For example, the computing-based device may be a server on which a server operating system is run (directly or within a virtual machine) and the content service may run as an application on the server operation system.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

The computer executable instructions may be provided using any computer-readable media that is accessible by computing based device 500. Computer-readable media may include, for example, computer storage media such as memory 506 and communications media. Computer storage media, such as memory 506, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 506) is shown within the computing-based device 500 it will be appreciated that the storage may be distributed or located remotely and accessed via a network (e.g. network 105) or other communication link (e.g. using communication interface 508).

The computing-based device 500 may also comprise an input/output controller arranged to output display information to a display device which may be separate from or integral to the computing-based device 500 and/or to receive and process input from one or more devices, such as a user input device (e.g. a mouse, keyboard, camera, microphone or other sensor). In some examples the user input device may detect voice input, user gestures or other user actions and may provide a natural user interface (NUI). The input/output controller may also output data to devices other than the display device.

Any of the input/output controller, display device and the user input device may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, RGB camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

Although the present examples are described and illustrated herein as being implemented in a system in which the content service 102, content generator device 108 and printer device 104 are connected via a network 105 (as shown in FIG. 1), the system described is provided as an example and not a limitation. As those skilled in the art will appreciate, the present examples are suitable for application in a variety of different types of systems and a computing device may act as a content generator and a printer device or a content service and content generator, etc. Furthermore, any suitable communication means may be used by the particular elements shown in FIG. 1 to communicate (e.g. point to point links, broadcast technologies, etc.).

A first further example provides a system comprising: a computing device running a content service; at least one display device; and at least one printer device, wherein the computing device comprises: a processor; a communication interface; and a memory arranged to store device-executable instructions that, when executed by the processor, direct the computing system to: identify content for display on a display device based at least in part on an identifier received via the communication interface, the identifier identifying a display device or a printer device; and provide the identified content to a printer device associated with the identifier received, wherein the display device comprises: an electronic paper display; a contact based conductive digital data and power bus; and a processing element configured to drive the electronic paper display, wherein the electronic paper display can only be updated when receiving power via the bus from the printer device; and wherein the printer device comprises: a power management device configured to supply at least one voltage level for driving the electronic paper display to the contact based conductive digital data and power bus in a display device via one or more contacts on an exterior of the printer device; and a processing element configured to supply pixel data for the electronic paper display to the contact based conductive digital data and power bus via two or more contacts on the exterior of the printer device.

A second further example provides a computing device comprising: a processor; a communication interface; and a memory arranged to store device-executable instructions that, when executed by the processor, direct the computing system to: identify content for display on a display device based at least in part on an identifier received via the communication interface, the identifier identifying the display device or a printer device; and provide the identified content to a printer device associated with the identifier received, wherein the display device comprises a electronic paper display, a contact based conductive digital data and power bus and a processing element configured to drive the electronic paper display, wherein the electronic paper display can only be updated when receiving power via the bus from a power supply external to the display device, and wherein the printer device comprises a power management device configured to supply at least one voltage level for driving the electronic paper display to the contact based conductive digital data and power bus in a display device via one or more contacts on an exterior of the printer device and a processing element configured to supply pixel data for the electronic paper display to the contact based conductive digital data and power bus via two or more contacts on the exterior of the printer device.

A third further example provides a computing device comprising: a communication interface configured to receive an identifier, the identifier identifying the display device or a printer device; and a processor configured to identify content for display on a display device based at least in part on the identifier received and provide the identified content to a printer device associated with the identifier received, wherein the display device comprises a electronic paper display, a contact based conductive digital data and power bus and a processing element configured to drive the electronic paper display, wherein the electronic paper display can only be updated when receiving power via the bus from a power supply external to the display device, and wherein the printer device comprises a power management device configured to supply at least one voltage level for driving the electronic paper display to the contact based conductive digital data and power bus in a display device via one or more contacts on an exterior of the printer device and a processing element configured to supply pixel data for the electronic paper display to the contact based conductive digital data and power bus via two or more contacts on the exterior of the printer device.

In the first, second or third further example, the identifier received may comprise an identifier for a printer device and wherein providing the identified content to the printer device associated with the identifier received comprises: providing the identified content to the printer device with an identifier matching the identifier received.

In the first, second or third further example, the identifier received may comprise an identifier for the display device and wherein providing the identified content to the printer device associated with the identifier received comprises: providing the identified content to the printer device currently connected to the display device with an identifier matching the identifier received.

The processor may be further configured to: access one or more operational parameters; format the identified content based on the accessed operational parameters; and transmit the formatted content to the printer device associated with the identifier received. The one or more operational parameters may comprise operational parameters for the display device connected to the printer device associated with the identifier received or operational parameters for the printer device associated with the identifier received. The one or more operational parameters may define a location of a button on the printer device associated with the identifier received and wherein formatting the identified content based on the accessed operational parameters comprises: generating a composite image comprising the identified content and an icon for the button.

The communication interface may be further configured to receive a second identifier for a user of the display device, and wherein the processor may be configured to: access one or more user preferences associated with the second identifier; format the identified content based on the accessed user preference; and transmit the formatted content to the printer device associated with the identifier received for the display device or printer device.

The communication interface may be further configured to receive contextual data associated with the printer device associated with the identifier received, and wherein the processor may be configured to: identify content based at least in part on the identifier received; and filter the identified content based on the contextual data. The contextual data may comprise data identifying a trigger causing the sending of the identifier for the display device and/or the identifier for the printer device to the computing device.

The processor may be further configured to: transmit additional non-display content to the printer device associated with the identifier received.

The processor may be further configured to: generate the additional non-display content by analyzing the identified content. The additional non-display content may comprise a link to the identified content or a link to content related to the identified content or an identifier for the identified content.

The processor may be further configured to: apply a filter to the identified content based on a restriction associated with the identified content.

In the first, second or third further example, the identifier for the display device and/or the identifier for the printer device may be received from the printer device associated with the identifier received or from a handheld computing device comprising a proximity based wireless device reader and wherein the identifier is stored in a proximity based wireless device in the display device and/or the printer device.

The communication interface may be further configured to: receive an identifier for a piece of content; and the processor may be further configured to: associating the identifier for the piece of content with an identifier for the display device and/or printer device, and wherein identifying content for display on the display device based at least in part on the identifier received comprises: identifying content for display on the display device based at least in part on the identifier for the display device and/or printer device and an associated identifier for the piece of content.

A fourth further example provides a system comprising a computing device according to the second or third further examples and at least one of the display device and the printer device.

A fifth further example provides a method comprising: receiving, at a computing device, an identifier for a display device and/or an identifier for a printer device; identifying content for display on the display device based at least in part on the identifier received; and providing the identified content to the printer device associated with the identifier received, wherein the display device comprises an electronic paper display, a contact based conductive digital data and power bus and a processing element configured to drive the electronic paper display, wherein the electronic paper display can only be updated when receiving power via the bus from a power supply external to the display device, and wherein the printer device comprises a power management device configured to supply at least one voltage level for driving the electronic paper display to the contact based conductive digital data and power bus in the display device via one or more contacts on an exterior of the printer device and a processing element configured to supply pixel data for the electronic paper display to the contact based conductive digital data and power bus via two or more contacts on the exterior of the printer device.

In the fifth further example, the identifier received may comprise an identifier for a printer device and wherein providing the identified content to the printer device associated with the identifier received comprises: providing the identified content to the printer device with an identifier matching the identifier received.

In the fifth further example, the identifier received may comprise an identifier for the display device and wherein providing the identified content to the printer device associated with the identifier received comprises: providing the identified content to the printer device currently connected to the display device with an identifier matching the identifier received.

In the fifth further example, providing the identified content to the printer device associated with the identifier received may comprise: accessing one or more operational parameters; formatting the identified content based on the accessed operational parameters; and transmitting formatted content to the printer device associated with the identifier received. The one or more operational parameters comprise operational parameters for the display device connected to the printer device associated with the identifier received or operational parameters for the printer device associated with the identifier received. The one or more operational parameters may define a location of a button on the printer device associated with the identifier received and wherein formatting the identified content based on the accessed operational parameters comprises: generating a composite image comprising the identified content and an icon for the button.

In the fifth further example, the method may further comprise receiving, at the computing device, a second identifier for a user of the display device, and wherein providing the identified content to the printer device associated with the identifier received comprises: accessing one or more user preferences associated with the second identifier; formatting the identified content based on the accessed user preference; and transmitting formatted content to the printer device associated with the identifier received for the display device or printer device.

In the fifth further example, identifying content for display on the display device based at least in part on the identifier received may comprise: receiving, at the computing device, contextual data associated with the printer device associated with the identifier received; identifying content based at least in part on the identifier received; and filtering the identified content based on the contextual data.

In the fifth further example, the contextual data may comprise data identifying a trigger causing the sending of the identifier for the display device and/or the identifier for the printer device to the computing device.

In the fifth further example, the method may further comprise transmitting additional non-display content to the printer device associated with the identifier received.

In the fifth further example, the method may further comprise generating, at the computing device, the additional non-display content by analyzing the identified content.

The additional non-display content may comprise a link to the identified content or a link to content related to the identified content or an identifier for the identified content.

In the fifth further example, the method may further comprise applying a filter to the identified content based on a restriction associated with the identified content.

In the fifth further example, the identifier for the display device and/or the identifier for the printer device may be received from the printer device associated with the identifier received or a handheld computing device comprising a proximity based wireless device reader and wherein the identifier is stored in a proximity based wireless device in the display device and/or the printer device.

In the fifth further example, the method may further comprise: receiving, at the computing device, an identifier for a piece of content; and associating the identifier for the piece of content with an identifier for the display device and/or printer device, and wherein identifying content for display on the display device based at least in part on the identifier received comprises: identifying content for display on the display device based at least in part on the identifier for the display device and/or printer device and an associated identifier for the piece of content.

In any of the further examples above, the electronic paper display may be a multi-stable display.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A system comprising:
a computing device running a content service;
at least one display device; and
at least one printer device,
wherein the computing device comprises:
a processor;
a communication interface; and
a memory arranged to store device-executable instructions that, when executed by the processor, direct the computing system to:
identify content for display on a display device based at least in part on an identifier received via the communication interface, the identifier identifying a display device or a printer device; and
provide the identified content to a printer device associated with the identifier received,
wherein the display device comprises:
an electronic paper display;
a contact based conductive digital data and power bus; and
a processing element configured to drive the electronic paper display, wherein the electronic paper display can only be updated when receiving power via the bus from the printer device;
and wherein the printer device comprises:
a power management device configured to supply at least one voltage level for driving the electronic paper display to the contact based conductive digital data and power bus in a display device via one or more contacts on an exterior of the printer device; and
a processing element configured to supply pixel data for the electronic paper display to the contact based conductive digital data and power bus via two or more contacts on the exterior of the printer device.

2. A method comprising:
receiving, at a computing device, an identifier for a display device and/or an identifier for a printer device;
identifying content for display on the display device based at least in part on the identifier received; and
providing the identified content to the printer device associated with the identifier received,
wherein the display device comprises an electronic paper display, a contact based conductive digital data and power bus and a processing element configured to drive the electronic paper display, wherein the electronic paper display can only be updated when receiving power via the bus from a power supply external to the display device, and
wherein the printer device comprises a power management device configured to supply at least one voltage level for driving the electronic paper display to the contact based conductive digital data and power bus in the display device via one or more contacts on an exterior of the printer device and a processing element configured to supply pixel data for the electronic paper display to the contact based conductive digital data and power bus via two or more contacts on the exterior of the printer device.

3. The method according to claim 2, wherein the identifier received comprises an identifier for a printer device and wherein providing the identified content to the printer device associated with the identifier received comprises:
providing the identified content to the printer device with an identifier matching the identifier received.

4. The method according to claim 2, wherein the identifier received comprises an identifier for the display device and wherein providing the identified content to the printer device associated with the identifier received comprises:
providing the identified content to the printer device currently connected to the display device with an identifier matching the identifier received.

5. The method according to claim 2, wherein providing the identified content to the printer device associated with the identifier received comprises:
accessing one or more operational parameters;
formatting the identified content based on the accessed operational parameters; and
transmitting formatted content to the printer device associated with the identifier received.

6. The method according to claim 5, wherein the one or more operational parameters comprise operational parameters for the display device connected to the printer device associated with the identifier received.

7. The method according to claim 5, wherein the one or more operational parameters comprise operational parameters for the printer device associated with the identifier received.

8. The method according to claim 7, wherein the one or more operational parameters define a location of a button on the printer device associated with the identifier received and wherein formatting the identified content based on the accessed operational parameters comprises:
generating a composite image comprising the identified content and an icon for the button.

9. The method according to claim 2, further comprising:
receiving, at the computing device, a second identifier for a user of the display device,
and wherein providing the identified content to the printer device associated with the identifier received comprises:
accessing one or more user preferences associated with the second identifier;
formatting the identified content based on the accessed user preference; and
transmitting formatted content to the printer device associated with the identifier received for the display device or printer device.

10. The method according to claim 2, wherein identifying content for display on the display device based at least in part on the identifier received comprises:
receiving, at the computing device, contextual data associated with the printer device associated with the identifier received;
identifying content based at least in part on the identifier received; and
filtering the identified content based on the contextual data.

11. The method according to claim 10, wherein the contextual data comprises data identifying a trigger causing the sending of the identifier for the display device and/or the identifier for the printer device to the computing device.

12. The method according to claim 2, further comprising:
transmitting additional non-display content to the printer device associated with the identifier received.

13. The method according to claim 12, further comprising:
generating, at the computing device, the additional non-display content by analyzing the identified content.

14. The method according to claim 12, wherein the additional non-display content comprises a link to the identified content or to content related to the identified content.

15. The method according to claim 12, wherein the additional non-display content comprises an identifier for the identified content.

16. The method according to claim 2, further comprising:
applying a filter to the identified content based on a restriction associated with the identified content.

17. The method according to claim 2, wherein the identifier for the display device and/or the identifier for the printer device is received from the printer device associated with the identifier received.

18. The method according to claim 2, wherein the identifier for the display device and/or the identifier for the printer device is received from a handheld computing device comprising a proximity based wireless device reader and wherein the identifier is stored in a proximity based wireless device in the display device and/or the printer device.

19. The method according to claim 2, further comprising:
receiving, at the computing device, an identifier for a piece of content; and
associating the identifier for the piece of content with an identifier for the display device and/or printer device,
and wherein identifying content for display on the display device based at least in part on the identifier received comprises:
identifying content for display on the display device based at least in part on the identifier for the display device and/or printer device and an associated identifier for the piece of content.

20. A computing device comprising:
a processor;
a communication interface; and
a memory arranged to store device-executable instructions that, when executed by the processor, direct the computing system to:
identify content for display on a display device based at least in part on an identifier received via the communication interface, the identifier identifying the display device or a printer device; and
provide the identified content to a printer device associated with the identifier received,
wherein the display device comprises a electronic paper display, a contact based conductive digital data and power bus and a processing element configured to drive the electronic paper display, wherein the electronic paper display can only be updated when receiving power via the bus from a power supply external to the display device, and
wherein the printer device comprises a power management device configured to supply at least one voltage level for driving the electronic paper display to the contact based conductive digital data and power bus in a display device via one or more contacts on an exterior of the printer device and a processing element configured to supply pixel data for the electronic paper display to the contact based conductive digital data and power bus via two or more contacts on the exterior of the printer device.
